(19) United States
(12) Patent Application Publication
(10) Pub. No.: US 2007/0150690 A1
(43) Pub. Date: Jun. 28, 2007

(54) Method and apparatus for increasing virtual storage capacity in on-demand storage systems

(75) Inventors: Zhifeng Chen, Urbana, IL (US); Cesar A. Gonzales, Katonah, NY (US); Balakrishna Iyer, San Jose, CA (US); Dan E. Poff, Mahopac, NY (US); John T. Robinson, Yorktown Heights, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 11/318,420

(22) Filed: Dec. 23, 2005

(51) Int. Cl. G06F 12/00

(52) U.S. Cl. 711/170

(57) ABSTRACT

A method and apparatus are disclosed for increasing virtual storage capacity in on-demand storage systems. The method utilizes data compression to selectively compress data stored in a storage resource to reduce the utilization of physical storage space whenever such physical resources have been over committed and the demand for physical storage exceeds its availability. In one exemplary embodiment, the utilization of the capacity of a shared storage resource is monitored and data is selected for compression based on the utilization. The compression of the selected data is triggered in response to the monitoring results. In addition, policies and rules are defined that determine which data is selected for compression. For example, the selection of data may be based on one or more of the following: a degree of utilization of said capacity of said shared storage resource, a volume size of said data, an indicator of compressibility of said data, a frequency of use of said data, a manual selection of said data, and a predefined priority of said data. The disclosed methods improve the operation of virtual allocation by further enhancing the availability of physical space through data compression. Virtual allocation and block-based data compression techniques are utilized to improve storage efficiency with a minimal risk to system availability and reliability and with a minimal impact to performance (access time and latency).

### FIELD OF THE INVENTION

The present invention relates to the field of computer storage management, and more particularly, to methods and apparatus for selectively compressing data based on the rate of the capacity utilization of a shared storage resource.

### BACKGROUND OF THE INVENTION

In conformance with common industry usage, the data storage allocated to a computer application is referred to as a “volume.” A volume, in turn, is made up of “blocks” of data, where a block is a collection of bytes. In magnetic hard disk drives, for example, a block typically contains 512 bytes.

A common feature of most enterprise computer applications is that the amount of data used by such applications grows over time as the enterprise itself grows; it is therefore a common practice in the prior art to reserve data storage space with sufficient headroom to anticipate this growth. For example, in a database application, future growth may be anticipated by creating and reserving a volume with 1 Terabyte of storage capacity while—early in the deployment of the application—using only a few hundred Gigabytes, i.e. a fraction of the reserved capacity. If the unused capacity actually corresponds to unused but reserved physical storage space, the enterprise storage resources are being inefficiently utilized.

A different sort of problem happens when capacity is allocated efficiently by reserving only what is needed without consideration of future data growth. In this case, data requirements by applications may grow beyond the original allocation. In many computer centers, this may require that applications be stopped so that physical storage can be increased, reconfigured and reallocated manually. This stoppage, however, can lead to unacceptable performance of time critical applications. To improve the efficiency of physical storage utilization and to enhance the management of storage capacity, virtual-allocation methods can be used to decouple virtual volume allocation from logical volume usage (in the present disclosure, it is assumed that “logical” storage has a one-to-one correspondence to “physical” storage). With virtual allocation, logical storage is dynamically allocated only as it is actually utilized or consumed by computer applications, not when “virtual” capacity is reserved. Virtual allocation methods are particularly useful when storage resources are shared by multiple applications. In this case, unused virtual blocks do not consume logical or physical storage blocks so that unused physical blocks can be pooled together and be made available to all applications as needed. More specifically, as the demands of applications exceed their original volume allocations, the latter can be increased by using these pooled resources.

The virtual allocation concept is found in various forms in the prior art. For example Mergen, Rader, Roberts and Porter in “Evolution of Storage Facilities in AIX Version 3 for RISC System/6000 Processors”, IBM Journal of Research and Development, 34, 1, 1990, (incorporated by reference herein) described a method for addressing limited physical storage space in a much larger virtual space. Physical space is allocated only when necessary by loading, so-called, segment IDs in registers that contain prefixes to virtual storage addresses.

In summary, there are two significant advantages to virtual allocation: 1) efficient utilization of physical storage capacity and, 2) non-disruptive growth of allocated space, i.e., growth without interrupting the normal operation of host applications in a shared storage environment. One problem with virtual allocation, however, is that utilization efficiency comes with an increased risk of over commitment of system resources; that is, the system may fail if, all of a sudden, several applications sharing the same virtual storage start consuming most of their reserved virtual capacity. In this scenario, it is possible that the system may run out of physical (logical) storage space.

Virtual allocation methods must anticipate, therefore, the situations when physical storage resources have been over committed and the demand for physical storage exceeds its availability. A reliable system must implement policies which define actions that must be taken when these events occur. The most common action used in the prior art is to simply generate a warning or alert to human operators whenever the utilization of physical storage reaches a certain threshold (e.g., 90% of capacity). At this point, the operator can manually increase capacity by either adding more disks, by freeing up disk space by migrating volumes to other storage systems, or by deleting unnecessary data. This sort of policy relies on human operators and may be unsatisfactory in some circumstances. For example, in certain high availability systems, the applications' demand for data storage may increase faster than the ability of an operator to react to it. This could lead to unacceptable stoppages in critical commercial deployments.

A need, therefore, exists for a method to alleviate the cited problems associated with the virtual allocation of storage resources when physical storage resources have been over committed and the demand for physical storage exceeds its availability.

### SUMMARY OF THE INVENTION

Generally, a method and apparatus are disclosed for increasing virtual storage capacity in on-demand storage systems. The method utilizes data compression to selectively compress data stored in a shared storage resource to reduce the utilization of physical storage space whenever such physical resources have been over committed and the demand for physical storage exceeds its availability. In one exemplary embodiment, the utilization of the capacity of the shared storage resource is monitored and data is selected for compression based on the utilization. The compression of the selected data is triggered in response to the monitoring results. In addition, policies and rules are defined that determine which data is selected for compression. For example, the selection of data may be based on one or more of the following: a degree of utilization of said capacity of said shared storage resource, a volume size of said data, an indicator of compressibility of said data, a frequency of use of said data, a manual selection of said data, and a predefined priority of said data. The disclosed methods improve the operation of virtual allocation by further enhancing the availability of physical space through data compression. Virtual allocation and block-based data compression techniques are utilized to improve storage efficiency with a minimal risk to system availability and reliability and with a minimal impact to performance (access time and latency).

The disclosed enhanced virtual allocation method incorporates a policy that defines actions for freeing up physical disk space in Storage Area Networks (SANs) and Network Attached Storage (NAS) devices by automatically and selectively applying data compression to data in all or a portion of the blocks contained in logical volumes residing within such storage devices. In one exemplary embodiment, the policy requires that compression should be applied whenever physical storage utilization exceeds a fixed threshold, say 95% of the capacity of the shared storage resource. In this embodiment, the selection of data to which compression is applied could be based in one of various options. In one embodiment, a volume which falls in the category of “rarely” used is selected and compressed. In another exemplary embodiment, a volume that is the most compressible (not all data compresses equally) is selected and compressed. Alternatively, the largest data volume may be selected and compressed. In general, policies and rules combining size, compressibility and frequency of use may be utilized to select the data targeted for compression such that the overall system performance is minimally affected. The metrics for compressibility may be gathered simultaneously with the writing of uncompressed data, while metrics for frequency of use may be gathered whenever data is accessed be it for reading or writing of uncompressed data to the storage device. Furthermore, the disclosed methods can also be applied to direct-attached storage besides the network attached devices (such as SAN and NAS).

A more complete understanding of the present invention, as well as further features and advantages of the present invention, will be obtained by reference to the following detailed description and drawings.

### BRIEF DESCRIPTION OF THE DRAWINGS

FIG. 1 is a block diagram of the Storage Networking Industry Association (SNIA) block aggregation model of a computer network with data storage;

FIG. 2 is a block diagram of the block aggregation model of FIG. 1 incorporating a novel on-demand memory management compression and address remapping component;

FIG. 3 is a flow diagram illustrating the mapping of virtual, logical, and physical addresses; and

FIG. 4 is a flow chart of the novel on-demand memory management compression and address remapping component of FIG. 2.

### DETAILED DESCRIPTION

Data compression has been widely used in the prior art as a means to reduce both the storage and transmission capacity requirements of many computer applications. For example, file compression software is widely available for use in Linux and Windows environments (prominent examples of this software include pkzip, winzip, and gzip). Data compression has also been used as part of the Windows and Unix operating systems to transparently compress and store files in designated directories. Data compression hardware has also been integrated with storage device controllers to increase the capacity of physical disk arrays by storing compressed versions of data blocks instead of original blocks. For a general discussion of storage device controllers integrated with compression hardware, see, for example, IBM's RAMAC Virtual Array Controller, IBM Redbook SG24-4951-00, incorporated by reference herein.

The virtual allocation of storage capacity (also known as late allocation, just-in-time provisioning, over-allocation, delayed allocation, and allocation on-demand) has been used as a method to improve the management and efficient utilization of physical storage resources in storage area network (SAN) sub-systems. As noted above, the fundamental idea behind virtual storage allocation algorithms is that physical storage is consumed (allocated and used) on-demand, i.e., only when it is actually to be used, not when it is reserved or allocated as “virtual” or “logical” storage space. Typically, only a fraction of reserved storage is actually used; therefore, virtual allocation can increase the “virtual” capacity of physical storage devices by more efficiently utilizing all of the available physical space. Virtual allocation can be implemented through a so-called vitualization layer in either host software (e.g., in a Logical Volume Manager or LVM), or in the fabric of a storage network environment. In the latter case, the virtualization layer may be implemented in a separate appliance, or integrated into switches or routers, or directly in the controllers of physical storage subsystems.

The first case (LVM) is better suited for storage that is directly attached to a host. The second case is better suited for SAN and network area storage (NAS) environments and could be implemented as part of a network block aggregation appliance (in-band virtualization) which is placed in the network to intermediate between host I/O requests and access to physical storage resources. An example of such an appliance is described in IBM's Total Storage SAN Volume Controller (see, “IBM Total Storage, Introducing the SAN Volume Controller and SAN Integration Server,” IBM Redbooks SG24-6423-00). Finally, the third case could be used in either direct attached or network attached environments.

In any case, the virtualization layer implements the block aggregation functionality of the SNIA model and its purpose is to decouple hosts' accesses to virtual storage from accesses to physical storage resources. This set up facilitates separate and independent management of hosts and storage resources. In effect, this layer implements a mapping of virtual block addresses into logical block addresses in a manner that is transparent to host applications and, as such, it can easily incorporate virtual allocation features.

The concept of “network managed volumes” (NMV) which was introduced and implemented in DataCore's SANSymphony product is most relevant to the usage of virtual-allocation in the present invention (see, “Just Enough Space, Just-in-Time,” DataCore Software Corporation, Publication P077AA1, and “DataCore ‘Virtual Capacity’providing . . . ,” DataCore Software Corporation, Publication P077AA). It should be noted that since, by definition, a virtualization layer can be used to decouple virtual volumes from logical volumes, it is relatively easy to add virtual-allocation features in such a layer.

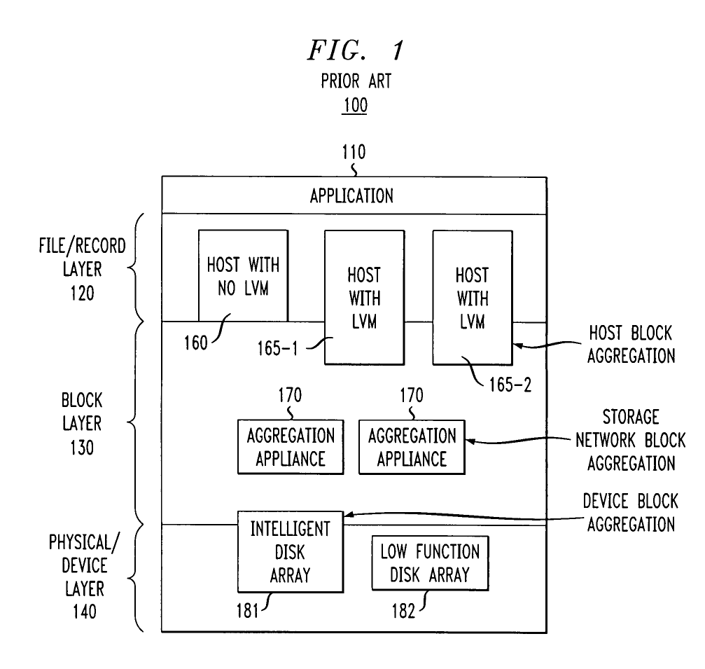

FIG. 1 is a block diagram of SNIA's shared storage model 100 of a computer network with data storage. The model 100 consists of an application layer 110, a file/record layer 120, a block layer 130, and a physical/device layer 140. It should be noted that in the original SNIA model the physical/device layer of FIG. 1 is the lower sub-layer of the record layer. In this invention, we prefer to distinguish the physical devices from the functionality provided by the block layer. The application layer 110 consists of various host applications that are beyond the scope of the present invention. The record layer 120 is responsible for assembling basic files (byte vectors) and database tuples (records) into larger entities, including storage device logical units and block-level volumes. Database management systems and file systems are components typically used in record layer 120 for access control, space allocation, and naming/indexing files and records. The record layer is normally implemented in a host, such as 160 in FIG. 1.

Block layer 130 enables the record layer 120 to access lower layer storage, including physical layer 140. The block layer 130 typically supports an interface to access one or more linear vectors of fixed-size blocks, such as the logical units of the SCSI interface. The data accessed through the block layer 130 is stored on devices such as intelligent disk array 181 and low function disk array 182 that are components of the physical layer 140. The storage provided by these devices can be used directly or it can be aggregated into one or more block vectors. This aggregation function is the responsibility of the block layer.

Block aggregation may also be performed at block layer 130 to enhance space management, to perform striping and to provide redundancy. Space management allows for the creation of a large block vector from several smaller block vectors. Striping provides increased throughput (and, potentially, reduced latency) by striping the data across the systems that provide lower-level block vectors. As shown in FIG. 1, block aggregation may be implemented in hosts 165-1,2 (collectively referred to as hosts 165 hereinafter) that have logical volume managers. Alternatively, block aggregation can be implemented in aggregation appliances 170 inserted in the network that connects hosts and storage devices. Finally, block aggregation can also be implemented as part of the controller of intelligent disk devices 181.

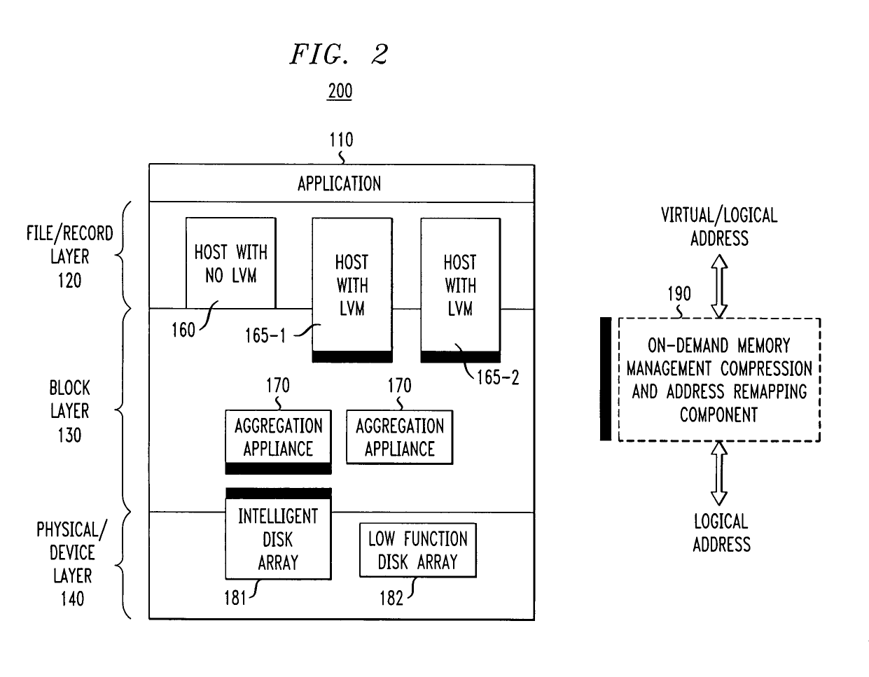

FIG. 2 is a block diagram of the block aggregation model of FIG. 1 incorporating a novel on-demand memory management compression and address remapping component 190. The present invention recognizes that data compression may be used to compress data stored in the physical layer 140 to reduce the capacity utilized when physical storage resources (such as intelligent disk array 181 and low function disk array 182) have been over committed and the demand for physical storage exceeds its availability. As illustrated in FIG. 2, the compression and address remapping may be performed in the block layer 130. Thus, the disclosed methods may be implemented as an additional software or hardware layer on top of SAN and NAS device controllers 181, or under the control of a virtualization appliance 170 or in the Logical Volume Manager lack of storage space. Very importantly, while the compression action could be executed manually by an operator, the preferred embodiment would be to effect compression automatically. In one exemplary embodiment, virtual volumes are manually assigned predefined priorities and compression is automatically applied to corresponding logical volumes based on these priorities. In another exemplary embodiment, volumes are monitored for size, compressibility and frequency of use, and logical volumes (or portions of volumes) are selected based on one or more of these metrics and the selected volumes (or portions) are compressed automatically, while minimizing the impact on total system performance. A user may also specify which data is to be compressed, or to specify which data is eligible to be compressed, if there is a shortage of shared storage capacity. Finally, with regard to NAS devices, it is important to note that blocks selected for compression could span full volumes, directories, subdirectories, or a subset of files within a volume or directory.

In the context of the present disclosure, the qualifier “virtual” describes parameters (e.g., volumes, disks, blocks, and addresses) in the interface that host computers 160, 165 use to access storage resources in a network of computers and shared storage devices. Typically, such access is through database or file system management software that utilizes initiator SCSI commands to address blocks in virtual disks. (For a general discussion of SCSI commands, see, for example, National Committee for Info. Tech. Stds. (NCITS), “SAM2, SCSI Architecture Model 2,” T10, Project 1157-D, Rev. 23 Mar. 16, 2002, incorporated by reference herein.) The term “logical interface” and the qualifier “logical” describe parameters (e.g., LUNs, disks, blocks, and addresses) which device controllers of physical storage resources in a direct- or network-attached storage environment utilize to target data blocks in physical disks. These device controllers manage the actual mapping from logical addresses of fixed-length blocks to corresponding physical blocks on disks which could be distributed over an array of physical disk drivers (e.g., Redundant Array of Independent Disks, or RAID). While the internal workings of storage system controllers is beyond the scope of the present invention, the logical abstractions presented by the controllers to the network environment will be described; such controllers typically behave as target SCSI devices.

It is noted that the qualifiers “virtual” and “logical” can be confusing as they are frequently used interchangeably to indicate the host's view of storage space (i.e., data addressing on a “physical” device). In the present disclosure, “virtual” and “logical” block addresses are distinguished because the present invention allows for a virtualization layer for translation between the hosts “virtual” block addresses and the “logical block addresses” presented by the storage device controllers 181, 182.

In some cases, this layer is implicit and trivial as when there is a one-to-one mapping from virtual address to logical address between hosts and attached or networked storage devices. In many other cases, however, virtual addresses are independent of logical addresses as when multiple hosts communicate with a pool of storage devices through a block aggregation appliance in a storage network environment. Thus, while it is assumed in this invention that logical blocks always have a one-to-one correspondence to physical blocks, it is not always true that virtual blocks are matched by corresponding logical blocks; the latter depends on the operation of the virtualization layer which could incorporate virtual allocation techniques.

In storage networks, the pool of shared storage resources is partitioned into logical volumes, where a logical volume is a collection of logical blocks in one or more SAN sub-systems. As previously noted, however, host computers address storage as virtual blocks in virtual volumes. Therefore, there is normally a one-to-one mapping between blocks in a logical volume and blocks in a virtual volume. Such mapping can be direct (host to storage device) or indirect, through a so-called, virtualization layer. A virtualization layer can be either implemented as a software program residing in the host 165 (e.g., the LVM), in a network appliance 170 logically positioned between hosts and physical storage resources 140 (e.g., Total Storage SAN Volume Controller manufactured by the IBM Corporation of Armonk, N.Y.; see, IBM Total Storage, Introducing the SAN Volume Controller and SAN Integration Server, IBM Redbooks SG24-6423-00, incorporated by reference herein), or even in storage device controllers 181. In any case, the virtualization layer implements the block aggregation functionality or the SNIA model and its purpose is to isolate a host's access to virtual storage from access to physical storage resources 140. This configuration facilitates separate and independent management of these two resources. The virtualization layer, in particular, implements a mechanism for mapping virtual addresses into logical addresses in the network, in a manner that is transparent to host applications.

Hosts 165 that communicate with NAS devices reference, store, and retrieve data objects as files (not blocks). Files, which are of arbitrary length, are typically identified by names and extensions which tag them as textual objects, computer programs, or other such objects. On the other hand, NAS heads and servers incorporate a file system layer, which as described above, ultimately communicates with the physical storage resources by also addressing virtual blocks. Thus, the present invention that compresses virtual blocks in a SAN environment can also be extended to NAS devices and to direct attached storage devices.

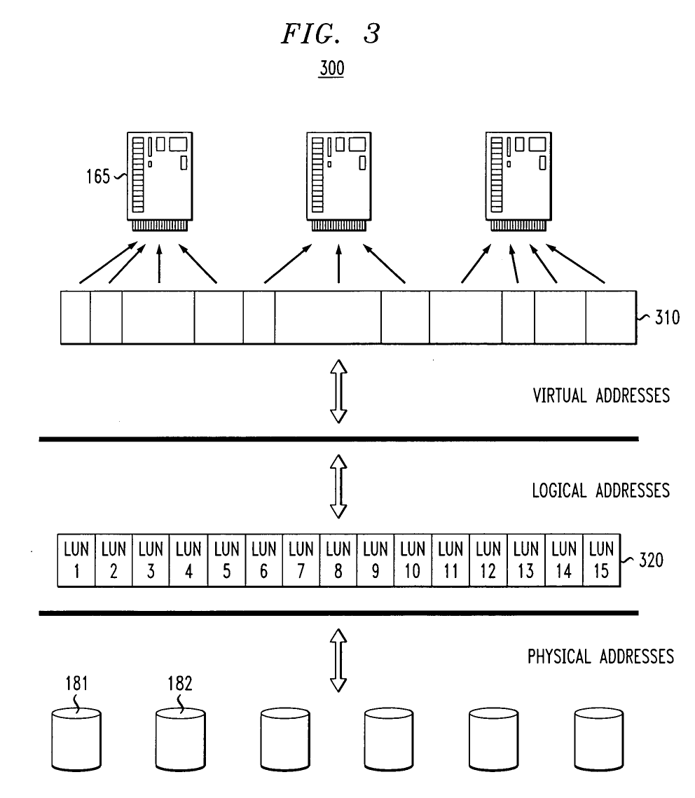

FIG. 3 illustrates the remapping of logical addresses (block addresses) to account for the variable-length of blocks that have been compressed. Hosts 165 partition data into logical volumes or virtual disks 310 utilizing virtual addresses. As a result of block aggregation, the virtual addresses are mapped to logical addresses of Logical Units, or LUNs 320. The logical addresses are then mapped to the physical addresses of the components 181, 182 in the physical layer 140. Since compressed blocks will typically occupy less space, new storage space will become available. The block addresses, however, will need to be remapped to deal with the variable-length of the compressed blocks or groups of blocks.

Thus, it should be noted that adding compression to the block aggregation layer 130 of a shared storage environment means that the simple one-to-one mapping of virtual blocks to logical blocks is broken. Compression results in blocks of variable-length and managing these will result in increased complexity and potentially decreased performance due to increased latencies in locating and accessing compressed blocks. In addition, the space savings of compression will also generally come at the expense of decreased system performance because of increased access times due to compression and decompression computations. It is important to note, however, that performance is not easy to predict in storage systems that incorporate compression technology. For example, while access times may increase because of the additional data processing requirements of compression, effective data transfer rates will also increase because compressed data generally occupies less space than uncompressed data. Thus, these two effects tend to balance each other. Furthermore, it is estimated that only 20% of the data in a typical storage system is actively used, i.e., the other 80% of the data is “rarely” accessed. This means that if only the “rarely used” 80% of the data is compressed and the frequently accessed 20% of the data is left in its original uncompressed state, there will be a very minimal impact on performance and a large savings in physical storage.

For the above reasons, careful policies and rules must be implemented to minimize impact to storage access performance. For example, in one exemplary embodiment, a policy requires that compression should be applied every time 95% of the capacity of the storage resource is reached. A volume which is categorized as “rarely used” is then selected and compressed, as defined by pre-defined rules. In an alternative embodiment, a volume that is the most compressible may be selected and compressed so as to free up the most physical space while impacting the minimum amount of data. Similarly, the largest volume(s) may be compressed. A person of ordinary skill in the art would recognize other algorithms for policies and rules combining size, compressibility and frequency of access use such that the resulting system performance is minimally affected. Furthermore, the metrics for compressibility and frequency of access use could be gathered simultaneously with the writing and reading of data.

Since data compression may effectively double or even triple storage capacity, the methods disclosed above, combined with the usual warning to an operator, could effectively guarantee that applications will never have to halt execution because of a lack of storage space. Very importantly, even though the compression action could be executed manually by an operator, the preferred embodiment would be to effect compression automatically. As described earlier, these methods could be implemented as an additional rule-based software or hardware layer on top of SAN and NAS device controllers, or under the control of a virtualization appliance 170 or software.

Many scenarios are possible for the policies and rules used to select the data to be compressed; some that minimize the impact on system performance by compressing specific groups of blocks have already been described above. In most environments, a host operating system typically partitions storage into Logical Volumes (LV) or Virtual Disks (VD). These are made up of collections of blocks associated with a particular host operating system (Linux, Windows, etc.) or application, such as a relational database. In alternative embodiments, therefore, compression could be applied to selected logical volumes or virtual disks rather than specific blocks or groups of blocks. A couple of examples follow:

1. Logical Virtual Volumes are manually assigned predefined priorities and compression is automatically applied to corresponding logical volumes based on these priorities.

2. Logical Volumes are monitored for size, compressibility and frequency of access use, and algorithms are developed based on any of these metrics to determine which logical volumes (or portions of volumes) are compressed automatically, while minimizing the impact on total system performance.

Policies also could be based on the importance of selected Logical Volumes in between the two listed above. Finally, with regard to NAS devices, it is important to note that blocks selected for compression could span full volumes, or directories, or subdirectories, or a subset of files within a volume or directory.

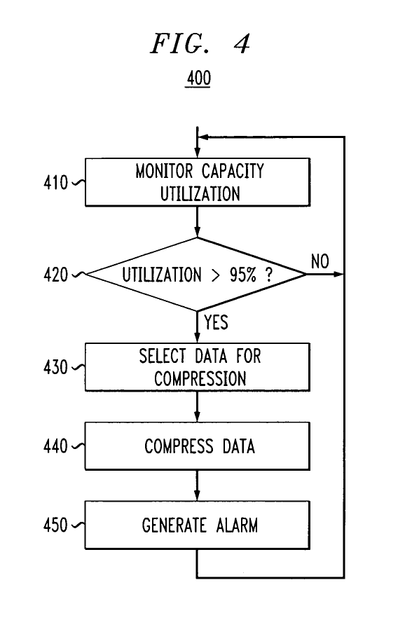

FIG. 4 is a flow diagram of a novel on-demand memory management compression component 400. During step 410, the rate of utilization of the capacity of the shared storage resource is monitored. A test is then performed during step 420 to determine if the capacity utilization exceeds 95%. If it is determined during step 420 that the capacity utilized does not exceed 95%, the monitoring step 410 is repeated. If it is determined during step 420 that the capacity utilized exceeds 95%, then data needs to be compressed. Thus, during step 430, data is selected for compression according to a rule-based policy, the selected data is compressed during step 440, and an alarm is generated in 450. The monitoring step 410 is then repeated.

It is to be understood that the embodiments and variations shown and described herein are merely illustrative of the principles of this invention and that various modifications may be implemented by those skilled in the art without departing from the scope and spirit of the invention.

What is claimed is:

1. A method for managing storage capacity in a storage resource, comprising the steps of:
monitoring utilization of said capacity of said storage resource;
selecting data for compression based on said utilization and on one or more rules; and
triggering compression of said selected data in response to said monitoring results.

2. The method of claim 1, wherein said selection of data is based on one or more of the following: a degree of utilization of said capacity of said storage resource, a volume size of said data, an indicator of compressibility of said data, a frequency of use of said data, a manual selection of said data, and a predefined priority of said data.

3. The method of claim 1, wherein said compression is applied to data in groups of blocks residing within said storage resource.

4. The method of claim 1, wherein said triggering compression step frees up physical space in said storage resource.

5. The method of claim 1, wherein said storage resource is a configuration of one or more SAN devices.

6. The method of claim 1, wherein said storage resource is a configuration of one or more NAS devices.

7. The method of claim 1, wherein said selecting and triggering steps are automatically executed without operator intervention.

8. An apparatus for managing storage capacity in a shared storage resource, comprising:
a memory; and
at least one processor, coupled to the memory, operative to:
monitor utilization of said capacity of said shared storage resource;
select data for compression based on said utilization and on one or more rules; and
trigger compression of said selected data in response to said monitoring results.

9. The apparatus of claim 8, wherein said selection of data is based on one or more of the following: a degree of utilization of said capacity of said shared storage resource, a volume size of said data, an indicator of compressibility of said data, a frequency of use of said data, a manual selection of said data, and a predefined priority of said data.

10. The apparatus of claim 8, wherein said compression is applied to data in groups of blocks residing within said shared storage resource.

11. The apparatus of claim 8, wherein said trigger compression step frees up physical space in said shared storage resource.

12. The apparatus of claim 8, wherein said shared storage resource is a configuration of one or more SAN devices.

13. The apparatus of claim 8, wherein said shared storage resource is a configuration of one or more NAS devices.

14. The apparatus of claim 8, wherein said selecting and triggering steps are automatically executed without operator intervention.

15. An article of manufacture for managing storage capacity in a shared storage resource, comprising a machine readable medium containing one or more programs which when executed implement the steps of:
monitoring utilization of said capacity of said shared storage resource;
selecting data for compression based on said utilization and on one or more rules; and
triggering compression of said selected data in response to said monitoring results.

16. The article of manufacture of claim 15, wherein said selection of data is based on one or more of the following: a degree of utilization of said capacity of said shared storage resource, a volume size of said data, an indicator of compressibility of said data, a frequency of use of said data, a manual selection of said data, and a predefined priority of said data.

17. The article of manufacture of claim 15, wherein said compression is applied to data in groups of blocks residing within said shared storage resource.

18. The article of manufacture of claim 15, wherein said triggering compression step frees up physical space in said shared storage resource.

19. The article of manufacture of claim 15, wherein said shared storage resource is a configuration of one or more of the following: a SAN device and a NAS device.

20. The article of manufacture of claim 15, wherein said selecting and triggering steps are automatically executed without operator intervention.
